(19) United States
(12) Patent Application Publication
(10) Pub. No.: US 2020/0409112 A1
(43) Pub. Date: Dec. 31, 2020

(54) LENS MODULE AND ELECTRONIC DEVICE

(71) Applicant: AAC Optics Solutions Pte. Ltd., Singapore city (SG)

(72) Inventor: Hailong Wang, Shenzhen (CN)

(21) Appl. No.: 16/916,097

(22) Filed: Jun. 29, 2020

(30) Foreign Application Priority Data
Jun. 30, 2019 (CN) PCT/CN2019/094067

(51) Int. Cl. G02B 13/00; G02B 7/02

(52) U.S. Cl. CPC G02B 13/0045; G02B 7/026; G02B 7/021

(57) ABSTRACT

The present disclosure provides a lens module and an electronic device. The electronic device comprises the lens module. The lens module comprises a lens barrel provided with a light-through hole and a receiving cavity in communication with the light-through hole, wherein, the lens barrel comprises an inner wall surface that encloses to form the receiving cavity and an outer wall surface provided opposite to the inner wall surface; and the outer wall surface comprises two first convex arc surfaces and two first cross-sections, and the two first convex arc surfaces and the two first cross-sections are alternately connected around the center line of the light-through hole. In the lens barrel of the present disclosure, since the outer wall surface comprises two first cross-sections, the size of the lens module is reduced, and the requirement for overall miniaturization of the lens module is satisfied without affecting the performance of the lens module.

### TECHNICAL FIELD

The present disclosure relates to a field of optical imaging to technology, in particular to a lens module and an electronic device.

### BACKGROUND

With the continuous development in science and technology, electronic devices continue to develop towards intelligence. In addition to digital cameras, portable electronic devices such as tablet computers and mobile phones are also equipped with lens modules with camera functions so as to meet the user's needs of taking photos at any time. At present, lenses are becoming more and more miniaturized. Not only head size of the lens module is expected to be smaller, but also overall size of the lens module is required to be smaller.

However, in the current technology, the overall size of the lens module is still large, which cannot meet the requirement on miniaturization.

Therefore, it is necessary to provide a miniaturized lens module.

### SUMMARY

One purpose of the present disclosure is to provide a lens module to meet the requirement on miniaturization of the overall size of the lens module.

The technical scheme of the present disclosure is as follows:

A lens module, comprising a lens barrel provided with a light-through hole and a receiving cavity in communication with the light-through hole, wherein, the lens barrel comprises an inner wall surface that encloses to form the receiving cavity and an outer wall surface provided opposite to the inner wall surface;

the outer wall surface comprises two first convex arc surfaces and two first cross-sections, and the two first convex arc surfaces and the two first cross-sections are alternately connected around a center line of the light-through hole.

As an improvement, the two first cross-sections are parallel to each other; and a distance between the two first cross-sections is smaller than a diameter of each of the first convex arc surfaces.

As an improvement, the inner wall surface comprises two second convex arc surfaces and two second cross-sections, and the two second convex arc surfaces and the two second cross-sections are alternately connected around the center line of the light-through hole.

As an improvement, the two second cross-sections and the two first cross-sections are parallel to each other; and a distance between the two second cross-sections is smaller than a diameter of each of the second convex arc surfaces.

As an improvement, the lens module further comprises a plurality of lenses stacked in the receiving cavity in a direction of the center line of the light-through hole, a lens among the plurality of lenses far away from the light-through hole comprises an object side surface and an image side surface provided opposite to each other, and a first connecting surface connecting the object side surface and the image side surface;

the first connecting surface comprises two third convex arc surfaces and two third cross-sections, wherein, the two third convex arc surfaces and the two third cross-sections are alternately connected around the center line of the light-through hole, the two third convex arc surfaces abut against the two second convex arc surfaces, respectively, and there are gaps left respectively between the two third cross-sections and the two second cross-sections.

As an improvement, the two third cross-sections and the two first cross-sections are parallel to each other; and a distance between the two third cross-sections is smaller than a diameter of each of the third convex arc surfaces.

As an improvement, the lens module further comprises a plurality of light shielding sheets provided between any two adjacent lenses, respectively, a light shielding sheet among the plurality of the light shielding sheets far away from the light-through hole comprises a first wall surface and a second wall surface abutting against the two adjacent lenses respectively, and a second connecting surface connected to the first wall surface and the second wall surface;

the second connecting surface comprises two fourth convex arc surfaces and two fourth cross-sections, the two fourth convex arc surfaces and the two fourth cross-sections are alternately connected around the center line of the light-through hole; the fourth convex arc surfaces abut against the two second convex arc surfaces respectively, and there are gaps left respectively between the two fourth cross-sections and the two second cross-sections.

As an improvement, the two fourth cross-sections and the two first cross-sections are parallel to each other; and a distance between the two fourth cross-sections is smaller than a diameter of each of the fourth convex arc surfaces.

As an improvement, the lens module further comprises a pressing ring, the pressing ring comprises a third wall surface, a fourth wall surface and a third connecting surface, the third wall surface abuts against a lens disposed farthest from the light-through hole, the fourth wall surface is provided opposite to the third wall surface in the direction of the center line of the light-through hole, and the third connecting surface connects the third wall surface and the fourth wall surface;

the third connecting surface comprises two fifth convex arc surfaces and two fifth cross-sections, the two fifth convex arc surfaces and the two fifth cross-sections are alternately connected around the center line of the light-through hole; the two fifth convex arc surfaces abut against the two second convex arc surfaces, respectively, and there are gaps left respectively between the two fifth cross-sections and the two second cross-sections.

The present disclosure also provides an electronic device comprising the above lens module.

The beneficial effects of the present disclosure include: the lens barrel is provided with a light-through hole and a receiving cavity in communication with the light-through hole, and the lens barrel comprises an inner wall surface that encloses to form the receiving cavity and an outer wall surface provided opposite to the inner wall surface, the outer wall surface comprises two first convex arc surfaces and two first cross-sections, and the two first convex arc surfaces and the two first cross-sections are alternately connected around a center line of the light-through hole. Since the outer wall surface of the lens barrel comprises two first cross-sections, and the connection between the first convex arc surface and the second convex arc surface is realized by the first cross-section and the second cross-section, the lens barrel in the present disclosure has a smaller structure, such that the size of the lens module is reduced, and the requirement for the overall miniaturization of the lens module is met without affecting the performance of the lens module, as compared with the traditional lens barrel composed entirely of arc surfaces.

The electronic device provided by the present disclosure comprises the above-mentioned lens module, and thus has all the beneficial effects of the lens module, which will not be repeated here.

### BRIEF DESCRIPTION OF THE DRAWINGS

FIG. 1 is a schematic view illustrating a cross-section structure of a lens module in an embodiment;

FIG. 2 is a schematic view illustrating a cross-section structure of a lens module in an embodiment;

FIG. 3 is a schematic view illustrating a structure of a lens barrel of the lens module in an embodiment;

FIG. 4 is a schematic view illustrating a structure of a fifth lens of the lens module in an embodiment;

FIG. 5 is a schematic view illustrating a structure of a light shielding sheet of the lens module of the present disclosure; and

FIG. 6 is a schematic view illustrating a structure of the pressing ring of the lens module of the present disclosure.

### DETAILED DESCRIPTION

The present disclosure will be further described below with reference to the drawings and embodiments.

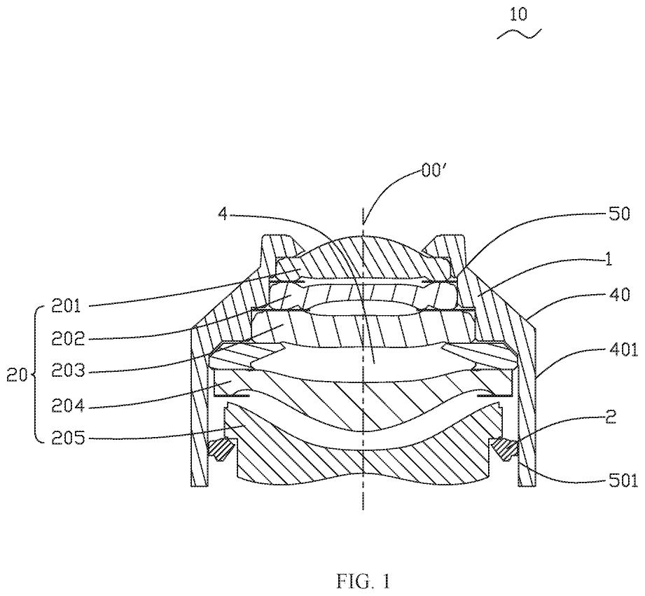

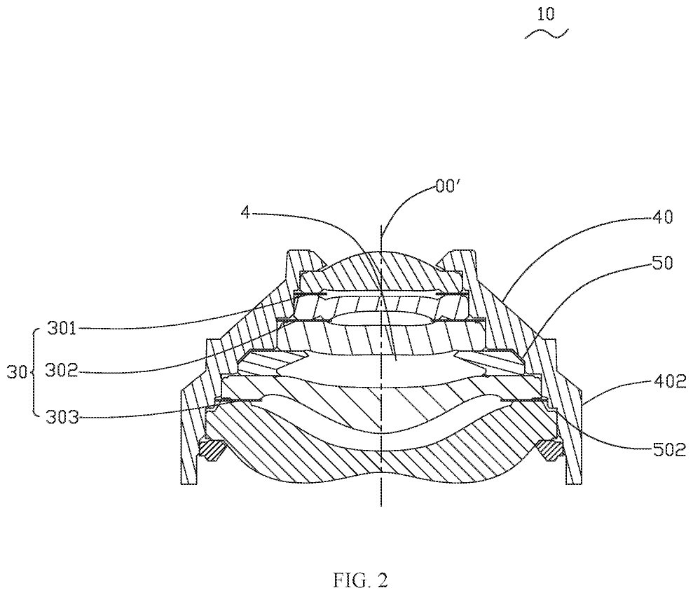

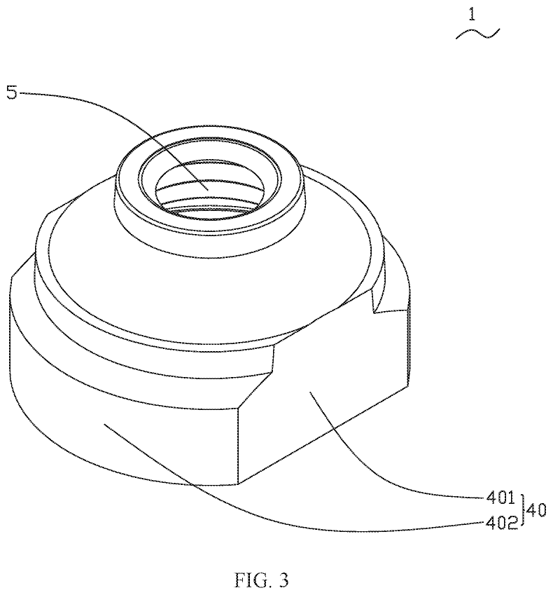

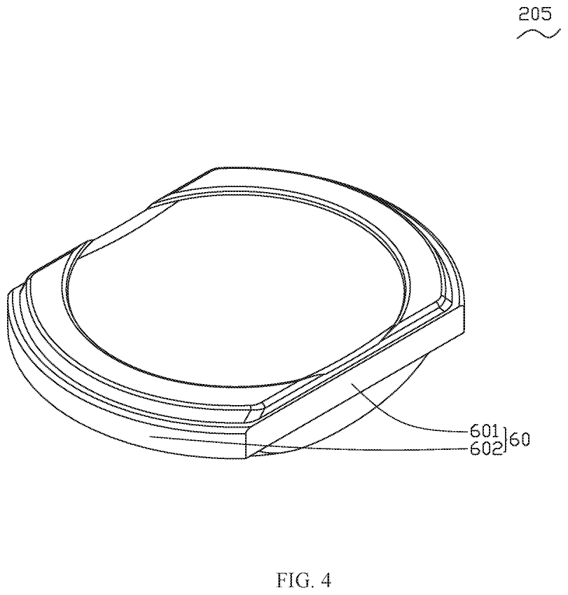

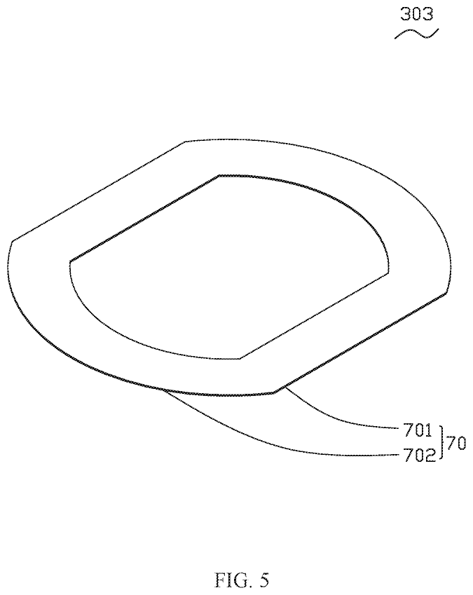

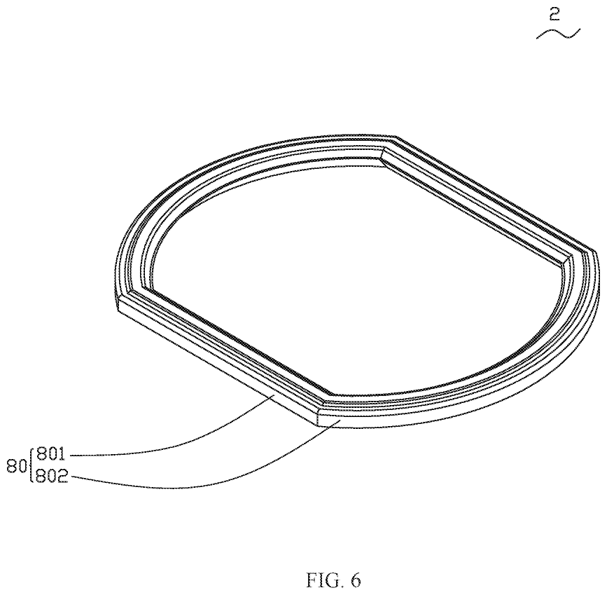

Referring to FIGS. 1-6, the present disclosure discloses a lens module 10 including a lens barrel 1, a lens group 20, a light shielding sheet group 30, and a pressing ring 2.

The lens barrel 1 is provided with a light-through hole 5 and a receiving cavity 4 in communication with the light-through hole 5. The lens barrel 1 comprises an inner wall surface 50 that encloses to form the receiving cavity 4 and an outer wall surface 40 provided opposite to the inner wall surface 50. The outer wall surface 40 comprises two first convex arc surfaces 402 and two first cross-sections 401, and the two first convex arc surfaces 402 and the two first cross-sections 401 are alternately connected around a center line of the light-through hole 5, that is, an edge of one of the first convex arc surfaces 402 is connected to an edge of the first cross-section 401, and the other edge of the first cross-section 401 is connected to an edge of the other first convex arc surface 402. As compared with the traditional lens barrel composed entirely of arc surfaces, as the outer wall surface 40 of the lens barrel 1 comprises two first cross-sections 401, the lens barrel 1 in the present disclosure has a smaller structure, such that the size of the lens module 10 is reduced, and the requirement on overall miniaturization of the lens module 10 is satisfied without affecting the performance of the lens module 10.

In an embodiment, the two first cross-sections 401 are parallel to each other, and a distance between the two first cross-sections 401 is smaller than a diameter of each of the first convex arc surfaces 402. In this arrangement, the size of the lens module 10 is reduced in the direction perpendicular to the first cross-sections 401, and the requirement for the miniaturization of the lens module 10 is satisfied without affecting the performance of the lens module 10.

In one embodiment, the inner wall surface 50 comprises two second convex arc surfaces 502 and two second cross-sections 501, and the two second convex arc surfaces 502 and two second cross-sections 501 are alternately connected around the center line of the light-through hole 5, that is, an edge of one of the second convex arc surfaces 502 is connected to an edge of the second cross-section 501, and the other edge of the second cross-section 501 is connected to an edge of the other second convex arc surface 502. In this arrangement, in the circumstance that an outer size of the lens barrel 1 is reduced, the size of an internal space of the lens barrel 1 is avoid to be reduced as much as possible.

In an embodiment, the two second cross-sections 501 are parallel to each other, and the two second cross-sections 501 and the two first cross-sections 401 are parallel to each other; a distance between the two second cross-sections 501 is smaller than a diameter of each of the second convex arc surfaces 502. In this arrangement, the wall thickness of the lens barrel 1 is more uniform, and the molding is more stable. In other words, the overall stability of the lens module 10 is improved, and the imaging quality is thus ensured.

In an embodiment, the lens module 10 further comprises a lens group 20 stacked in the receiving cavity 4 in a direction of the center line of the light-through hole 5, an optical axis 00′ of the lens group 20 coincides with the center line of the light-through hole 5. The lens group 20 includes the first lens 201, the second lens 202, the third lens 203, the fourth lens 204 and the fifth lens 205 in sequence, in the direction from the object side to the image side along the optical axis 00′. The lens in the lens group 20 far away from the light-through hole 5 (that is, the fifth lens 205) comprises an object side surface and an image side surface provided opposite to each other, and a first connecting surface 60 connecting the object side and the image side.

The first connecting surface 60 comprises two third convex arc surfaces 602 and two third cross-sections 601. The two third convex arc surfaces 602 and the third cross-sections 601 are alternately connected around the optical axis 00′, and an edge of one of the third convex arc surfaces 602 is connected an edge of the third cross-section 601, the other edge of the third cross-section 601 is connected to an edge of the other third convex arc surface 602. The two third convex arc surfaces 602 abut against the two second convex arc surfaces 502 respectively, and there are gaps left respectively between the two third cross-sections 601 and the two second cross-sections 501. In this arrangement, the fifth lens 205 can be used in cooperation with the lens barrel 1 with the second cross-section 501, and the requirement on the overall miniaturization of the lens module 10 is satisfied without affecting the performance of the lens module 10.

In an embodiment, the two third cross-sections 601 are parallel to each other, and the two third cross-sections 601 and the two first cross-sections 401 are parallel to each other. A distance between the two third cross-sections 601 is smaller than a diameter of each of the third convex arc surfaces 602. In this arrangement, the fifth lens 205 can be better used in cooperation with the lens barrel 1 with the second cross-section 501.

In an embodiment, the lens module 10 further comprises a plurality of light shielding sheet groups 30 provided between any two adjacent lenses, respectively, and the light shielding sheets of the light shielding sheet group 30 arc sandwiched between the first lens 201 and the second lens 202, the second lens 202 and the third lens 203, and the fourth lens 204 and the fifth lens 205, respectively. The light shielding sheet group 30 includes the first light shielding sheet 301, the second light shielding sheet 302, the third light shielding sheet 303 in sequence, in the direction from the object side to the image side along the optical axis 00′. The light shielding sheet away from the light-through hole 5 (that is, the third light shielding sheet 303) comprises a first wall surface and a second wall surface abutting against the fourth lens 204 and the fifth lens 205 respectively, and a second connecting surface 70 connected to the first wall surface and the second wall surface.

The second connecting surface 70 comprises two fourth convex arc surfaces 702 and two fourth cross-sections 701, the two fourth convex arc surfaces 702 and the two fourth cross-sections 701 are alternately connected around the center line of the optical axis 00′, that is, an edge of one of the fourth convex arc surfaces 702 is connected to an edge of the fourth cross-section 701, the other edge of the fourth cross-section 701 is connected to an edge of the other fourth convex arc surface 702. The two fourth convex arc surfaces 702 abut against the two second convex arc surfaces 502 respectively, and there are gaps left respectively between the two fourth cross-sections 701 and the two second cross-sections 501. In this arrangement, the third light shielding sheet 303 can be used in cooperation with the lens barrel 1 with the second cross-section 501, and the requirement for the overall miniaturization of the lens module 10 is satisfied without affecting the performance of the lens module 10.

In an embodiment, the two fourth cross-sections 701 are parallel to each other, and the two fourth cross-sections 701 and the two first cross-sections 401 are parallel to each other; there are gaps left respectively between the two fourth cross-sections 701 and the two second cross-sections 501, such that the third light shielding sheet 303 can be better used in cooperation with the lens barrel 1 with the second lens 202.

In an embodiment, the lens module 10 further comprises a pressing ring 2, the pressing ring 2 comprises a third wall surface, a fourth wall surface, and a third connecting surface 80. The third connecting surface 80 abuts against the lens disposed farthest away from the light-through hole 5, that is, the fifth lens 205. The fourth wall surface is provided opposite to the third wall surface in the direction of the optical axis 00′, and the third connecting surface 80 connects the third wall surface and the fourth wall surface.

The third connecting surface 80 comprises two fifth convex arc surfaces 802 and two fifth cross-sections 801, the two fifth convex arc surfaces 802 and the two fifth cross-sections 801 are alternately connected around the optical axis 00′, that is, an edge of one of the fifth convex arc surfaces 802 is connected to an edge of the fifth cross-section 801, the other edge of the fifth cross-section 801 is connected to an edge of the other fifth convex arc surface 802. The two fifth convex arc surfaces 802 abut against the two second convex arc surfaces 502, respectively. There are gaps left respectively between the two fifth cross-sections 801 and the two second cross-sections 501, such that the pressing ring 2 can be used in cooperation with the lens barrel 1 with the second cross-section 501, and the requirement for the overall miniaturization of the lens module 10 is satisfied without affecting the performance of the lens module 10.

In an embodiment, the two fifth cross-sections 801 are parallel to each other, and the two fifth cross-sections 801 and the first cross-sections 401 are parallel to each other, and a distance between the two fifth cross-sections 801 is smaller than the diameter of each of the fifth convex arc surfaces 802. In this arrangement, the pressing ring 2 can be better used in cooperation with the lens barrel 1 with the second cross-section 501.

The present disclosure also provides an electronic device, which includes the above-mentioned lens module 10. The electronic device provided by the present disclosure comprises the above-mentioned lens module 10, and thus has all the beneficial effects of the lens module 10, which will not be repeated here.

The above are only the embodiments of the present disclosure. It should be noted that, improvements can be made by those skill in the art without departing from the creative concept of the present disclosure, however, all of these belong to the protection scope of the present disclosure.

What is claimed is:

1. A lens module, comprising a lens barrel provided with a light-through hole and a receiving cavity in communication with the light-through hole, wherein,
the lens barrel comprises an inner wall surface that encloses to form the receiving cavity and an outer wall surface provided opposite to the inner wall surface; and
the outer wall surface comprises two first convex arc surfaces and two first cross-sections, and the two first convex arc surfaces and the two first cross-sections are alternately connected around a center line of the light-through hole.

2. The lens module according to claim 1, wherein the two first cross-sections are parallel to each other, and a distance between the two first cross-sections is smaller than a diameter of each of the first convex arc surfaces.

3. The lens module according to claim 1, wherein the inner wall surface comprises two second convex arc surfaces and two second cross-sections, and the two second convex arc surfaces and the two second cross-sections are alternately connected around the center line of the light-through hole.

4. The lens module according to claim 3, wherein the two second cross-sections and the two first cross-sections are parallel to each other; and a distance between the two second cross-sections is smaller than a diameter of each of the second convex arc surfaces.

5. The lens module according to claim 3, wherein the lens module further comprises a plurality of lenses stacked in the receiving cavity in a direction of the center line of the light-through hole, a lens among the plurality of lenses far away from the light-through hole comprises an object side surface and an image side surface provided opposite to each other, and a first connecting surface connecting the object side surface and the image side surface;
the first connecting surface comprises two third convex arc surfaces and two third cross-sections, wherein, the two third convex arc surfaces and the two third cross-sections are alternately connected around the center line of the light-through hole, the two third convex arc surfaces abut against the two second convex arc surfaces respectively, and there are gaps left respectively between the two third cross-sections and the two second cross-sections.

6. The lens module according to claim 5, wherein the two third cross-sections and the two first cross-sections are parallel to each other; and a distance between the two third cross-sections is smaller than a diameter of each of the third convex arc surfaces.

7. The lens module according to claim 5, wherein the lens module further comprises a plurality of light shielding sheets provided respectively between any two adjacent lenses, a light shielding sheet among the plurality of the light shielding sheets far away from the light-through hole comprises a first wall surface and a second wall surface abutting against the two adjacent lenses respectively, and a second connecting surface connected to the first wall surface and the second wall surface;
the second connecting surface comprises two fourth convex arc surfaces and two fourth cross-sections, the two fourth convex arc surfaces and the two fourth cross-sections are alternately connected around the center line of the light-through hole; the fourth convex arc surfaces abut against the two second convex arc surfaces respectively, and there are gaps left respectively between the two fourth cross-sections and the two second cross-sections.

8. The lens module according to claim 7, wherein the two fourth cross-sections and the two first cross-sections are parallel to each other; and a distance between the two fourth cross-sections is smaller than a diameter of each of the fourth convex arc surfaces.

9. The lens module according to claim 5, wherein the lens module further comprises a pressing ring, the pressing ring comprises a third wall surface, a fourth wall surface and a third connecting surface, the third wall surface abuts against a lens disposed farthest away from the light-through hole, the fourth wall surface is provided opposite to the third wall surface in the direction of the center line of the light-through hole, and the third connecting surface connects the third wall surface and the fourth wall surface;
the third connecting surface comprises two fifth convex arc surfaces and two fifth cross-sections, the two fifth convex arc surfaces and the two fifth cross-sections are alternately connected around the center line of the light-through hole; the two fifth convex arc surfaces abut against the two second convex arc surfaces respectively, and there are gaps left respectively between the two fifth cross-sections and the two second cross-sections.

10. The lens module according to claim 4, wherein the lens module further comprises a plurality of lenses stacked in the receiving cavity in a direction of the center line of the light-through hole, a lens among the plurality of lenses far away from the light-through hole comprises an object side surface and an image side surface provided opposite to each other, and a first connecting surface connecting the object side surface and the image side surface;
the first connecting surface comprises two third convex arc surfaces and two third cross-sections, wherein, the two third convex arc surfaces and the two third cross-sections are alternately connected around the center line of the light-through hole, the two third convex arc surfaces abut against the two second convex arc surfaces respectively, and there are gaps left respectively between the two third cross-sections and the two second cross-sections.

11. An electronic device, comprising a lens module, wherein, the lens module comprises a lens barrel provided with a light-through hole and a receiving cavity in communication with the light-through hole, wherein,
the lens barrel comprises an inner wall surface that encloses to form the receiving cavity and an outer wall surface provided opposite to the inner wall surface; and
the outer wall surface comprises two first convex arc surfaces and two first cross-sections, and the two first convex arc surfaces and the two first cross-sections are alternately connected around a center line of the light-through hole.

12. The electronic device according to claim 11, wherein the two first cross-sections are parallel to each other, and a distance between the two first cross-sections is smaller than a diameter of each of the first convex arc surfaces.

13. The electronic device according to claim 11, wherein the inner wall surface comprises two second convex arc surfaces and two second cross-sections, and the two second convex arc surfaces and the two second cross-sections are alternately connected around the center line of the light-through hole.

14. The electronic device according to claim 13, wherein the two second cross-sections and the two first cross-sections are parallel to each other; and a distance between the two second cross-sections is smaller than a diameter of each of the second convex arc surfaces.

15. The electronic device according to claim 13, wherein the lens module further comprises a plurality of lenses stacked in the receiving cavity in a direction of the center line of the light-through hole, a lens among the plurality of lenses far away from the light-through hole comprises an object side surface and an image side surface provided opposite to each other, and a first connecting surface connecting the object side surface and the image side surface;
the first connecting surface comprises two third convex arc surfaces and two third cross-sections, wherein, the two third convex arc surfaces and the two third cross-sections are alternately connected around the center line of the light-through hole, the two third convex arc surfaces abut against the two second convex arc surfaces respectively, and there are gaps left respectively between the two third cross-sections and the two second cross-sections.

16. The electronic device according to claim 15, wherein the two third cross-sections and the two first cross-sections are parallel to each other; and a distance between the two third cross-sections is smaller than a diameter of each of the third convex arc surfaces.

17. The electronic device according to claim 15, wherein the lens module further comprises a plurality of light shielding sheets provided respectively between any two adjacent lenses, a light shielding sheet among the plurality of the light shielding sheets far away from the light-through hole comprises a first wall surface and a second wall surface abutting against the two adjacent lenses respectively, and a second connecting surface connected to the first wall surface and the second wall surface;
the second connecting surface comprises two fourth convex arc surfaces and two fourth cross-sections, the two fourth convex arc surfaces and the two fourth cross-sections are alternately connected around the center line of the light-through hole; the fourth convex arc surfaces abut against the two second convex arc surfaces respectively, and there are gaps left respectively between the two fourth cross-sections and the two second cross-sections.

18. The electronic device according to claim 17, wherein the two fourth cross-sections and the two first cross-sections are parallel to each other; and a distance between the two fourth cross-sections is smaller than a diameter of each of the fourth convex arc surfaces.

19. The electronic device according to claim 15, wherein the lens module further comprises a pressing ring, the pressing ring comprises a third wall surface, a fourth wall surface and a third connecting surface, the third wall surface abuts against a lens disposed farthest away from the light-through hole, the fourth wall surface is provided opposite to the third wall surface in the direction of the center line of the light-through hole, and the third connecting surface connects the third wall surface and the fourth wall surface;
the third connecting surface comprises two fifth convex arc surfaces and two fifth cross-sections, the two fifth convex arc surfaces and the two fifth cross-sections are alternately connected around the center line of the light-through hole; the two fifth convex arc surfaces abut against the two second convex arc surfaces respectively, and there are gaps left respectively between the two fifth cross-sections and the two second cross-sections.

20. The electronic device according to claim 14, wherein the lens module further comprises a plurality of lenses stacked in the receiving cavity in a direction of the center line of the light-through hole, a lens among the plurality of lenses far away from the light-through hole comprises an Object side surface and an image side surface provided opposite to each other, and a first connecting surface connecting the object side surface and the image side surface;
the first connecting surface comprises two third convex arc surfaces and two third cross-sections, wherein, the two third convex arc surfaces and the two third cross-sections are alternately connected around the center line of the light-through hole, the two third convex arc surfaces abut against the two second convex arc surfaces respectively, and there are gaps left respectively between the two third cross-sections and the two second cross-sections.
